(19) United States
(12) Patent Application Publication
(10) Pub. No.: US 2014/0365384 A1
(43) Pub. Date: Dec. 11, 2014

(54) CROSS-STORE LICENSING FOR THIRD PARTY PRODUCTS

(71) Applicant: Microsoft Corporation, Redmond, WA (US)

(72) Inventors: David Mowatt, Dalkey (IE); David Ahs, Dublin (IE); Pieter Kasselman, Dublin (IE); Owen O'Brien, Dublin (IE); Terry Farrell, Dublin (IE)

(21) Appl. No.: 13/914,562

(22) Filed: Jun. 10, 2013

(51) Int. Cl. G06Q 50/18

(52) U.S. Cl. CPC G06Q 50/184
USPC 705/310

(57) ABSTRACT

A global licensing service facilitates the mapping of consumers to purchases made by the consumer in one or more stores. One or more consumer identifiers used by a consumer in various stores are stored in a central data store. The various consumer identifiers are mapped to purchases made by the consumer to provide a centralized transaction mapping. The global licensing service may enable cross-store licensing by providing a way in which a store may determine that a consumer has previously purchased a product in another store. In some implementations, if the consumer has previously purchased a product, the consumer may be offered the product for free or offered a discount price for the product.

### BACKGROUND

The computing device marketplace has increasingly become fragmented over the past several decades. A multitude of companies offer company-branded products that are specifically geared to work on devices offered by the companies. From laptops to personal computers (PC), tablets to smartphones, the types of devices available for use by a consumer increases year-by-year. Consumers often select one or more devices based on the convenience of the device or for the capabilities that the device may offer. A consumer may use a PC for work and use a tablet for personal activities. Consumers also increasingly use smartphones for various aspects of their life and work, adding to the interconnected nature of personal and work computing.

In addition to using various types of devices, consumers typically use devices sold by more than one company. It is not unusual for a consumer to use a wireless mobile device made by one manufacturer, a tablet made by a second manufacturer, and a laptop made by a third manufacturer. Consumers often use more than one device to perform the same function. Consumers may use a PC, a tablet, and a wireless mobile device to check email, write documents, perform research, and the like.

Because of the overlap between devices and their use, manufacturers of the devices attempt to use proprietary or company-specific technology to differentiate themselves from the competition. Along with company-created applications and services offered in the online application stores, companies will typically encourage third-party developers and service-providers to offer their applications or services in their application store. Depending on the particular company, the applications or services provided in these stores may be configured to work only on devices sold by the company that provides that store.

Developers also suffer from a fragmented marketplace. The developer will often be required to develop applications or services that work on company-specific devices in order to be allowed to sell the application or service in the store. Further, the interaction between a developer and the consumer can be fragmented because of the need for the consumer to often access multiple stores for the same application or service. The inability of the developer to interact with a consumer on a consistent basis may not create a trusting relationship between the developer and the consumer. Further, the consumer may not appreciate having to purchase the same application or service repeatedly for each device the consumer owns. Developers may attempt to create a unitary marketplace for their applications or services by selling their applications or services directly in their own store, but this may require the developer to establish a payment system as well as system for tracking licenses. Also, without the market exposure provided by application stores, the developer may need to expend time and energy marketing their products.

The fragmentation experienced by consumers and developers can translate to economic losses for companies. The fragmentation may reduce the desire of a consumer to access a particular company's store on a particular device because of the additional effort and cost needed to perform a transaction to receive the application or benefit from an application or service previously purchased from the developer by the consumer. A consumer may simply determine that the additional effort is not worth the effort and forgo entering into another transaction.

It is with respect to these and other considerations that the disclosure made herein is presented.

### SUMMARY

Concepts and technologies are described herein for cross-store licensing for third party products. In some configurations, a global licensing service is provided. The global licensing service can track purchases of products of a consumer across multiple stores by providing a centralized mapping of transactions involving the consumer in various stores. In one implementation, the global licensing service maps various identifiers and provides those identifiers to different entities to facilitate cross-store licensing. One identifier may be a global consumer identifier for a specific consumer. The global consumer identifier may be associated with one or more identifiers used by the consumer in various stores. Another identifier may be a global product identifier for a specific product. The global product identifier may be associated with one or more products sold in various stores.

These and other global identifiers may be mapped and stored by the global licensing service. The mapping may be made available for reference by a store, a consumer, or a developer. A store may use a global consumer identifier to determine if a consumer accessing the store has purchased a product indicated by the consumer at another store. Upon receipt of information that the consumer has purchased a particular product in another store, the store may alter the consumer experience by changing the price, offering the product for free, or in other ways. A developer may associate similar products sold in various stores using a single global product identifier. A store or consumer may then use the global product identifier to facilitate a transaction across various stores or independently of the stores.

It should be appreciated that the above-described subject matter may also be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the concepts and technologies disclosed herein, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a system diagram showing a computing system configured for cross-store licensing, in accordance with some embodiments.

FIG. 2 is a flow diagram illustrating an exemplary method for determining the price of a product sold in one store based on a purchase by the consumer of the product in another store, in accordance with some embodiments.

FIG. 3 is a block diagram illustrating an exemplary method for provisioning pairs of identifiers, in accordance with some embodiments.

FIG. 4 is a user interface (UI) diagram illustrating several interfaces that can be used by a developer in a global licensing service, in accordance with some embodiments.

FIG. 5 is a system diagram illustrating the registration of multiple devices with a global licensing service, in accordance with some embodiments.

FIG. 6 is a block diagram illustrating an exemplary method for mapping a new product in a store natively integrated with a global licensing service, in accordance with some embodiments.

FIG. 7 is a block diagram illustrating an exemplary method for mapping a new product in a store not natively integrated with a global licensing service, in accordance with some embodiments.

FIG. 8 is a block diagram illustrating an exemplary method for mapping a consumer transaction in a store natively integrated with a global licensing service, in accordance with some embodiments.

FIG. 9 is a computer architecture diagram showing an illustrative computer hardware and software architecture for a computing system capable of implementing aspects of the embodiments presented herein.

### DETAILED DESCRIPTION

The following detailed description is directed to concepts and technologies that, in various embodiments, are designed to enable cross-store licensing for third party products. In various configurations, a consumer may be able to receive the use of a product at a reduced cost in a store, such as an application store, based on a previous transaction. Some implementations of the present disclosure use a global licensing service that maps transactions involving the consumer across one or more stores and for one or more products. Upon receiving a section of a product for purchase or use, the application store may access the global licensing service to determine if the consumer should receive a product at a reduced cost.

In accordance with various aspects disclosed herein, a global licensing service is provided that maps information from disparate sources. The disparate sources may be from various components that form a marketplace, including a consumer, a store selling a product, a developer, or a supplier. As used herein, a “consumer” may include an individual, a corporation, or other entity. The information may be mapped to connect the information across various stores, devices, and consumers.

One identifier discussed briefly above is a global consumer identifier. A global consumer identifier may be generated for a particular consumer. The various identities the consumer may use in multiple stores may be mapped to the global consumer identifier. This mapping may be maintained in the global licensing service, an application store, or both. The global consumer identifier may be stored in a global licensing service consumers catalog data store (“consumer catalog”). Various entities may access the consumer catalog to determine, among other things, the identification of the consumer in various stores, previous purchases made by the consumer, whether or not the consumer has purchased a particular product, remaining uses of a particular product available to the consumer, as well as others.

The products purchased in various stores may be stored in a global licensing service paid product catalog data store (“paid product catalog”). The paid product catalog may help centralize license or purchase information across various stores to provide a developer with a single location to retrieve information relating to their particular product. The paid product catalog may associate the number of instances the product was sold to a particular store. This may help a developer determine the amount of royalties owed to the developer. For example, the information may help the developer determine, among other things, acquisition patterns of a given product across multiple stores, including where an initial purchase was made, which stores are most popular, the percentage of users that purchase the product across multiple stores, and the like.

A global licensing service consumers license mapping store (“license mapping store”) may provide a centralized data store that associates the information stored in the paid product catalog with the information stored in the consumer catalog. An entity may access the license mapping store to determine purchases of products made by a particular consumer or the consumers that have purchased a particular product. The license mapping store may also use the store-specific information stored in the paid product catalog to associate a particular consumer with a particular product in a particular store.

The global licensing service may be used by a developer to map a product across various stores to facilitate the use of their product across multiple devices and platforms. The developer may submit a product to the global licensing service. A global product identifier may be generated and associated with the identifiers of the product in each store. In this manner, the developer may help facilitate the purchase of their product across multiple stores or devices when the same product is purchased by a consumer in one of those stores or for one device. Further, in some implementations, the developer may facilitate the acquisition of their product on more favorable terms from a secondary store when the same product is already purchased by a consumer in a different store.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

As used herein, a “product” may include, but is not limited to, software applications or services. It should be understood that the presently disclosed subject matter is not limited to products in which a form of payment is required or expected from a provider of the product to a consumer of the product. In addition, a product may be a combination of complementary products distributed together as a bundle. The bundle may include the same type product, such as a software application, or a combination of different types of products, such as a combination of a software application and a service. The bundle may be provided in a store or various components of the bundle may be provided across several stores. Complementary products may include products designed to work with each other to perform one or more functions, as well as products having one language in one store and another language in another store.

As used herein, a “software application” may include, but is not limited to, a stand-alone software product or a software product intended to be used in conjunction with another software product. Further, as used herein, a “service” may include, but is not limited to, software-as-a-service, a periodical, a journal, a publication, news media, or a function provided by a software application. Furthermore, a service may include non-virtual components, including paid work by a person. Some examples of paid work include, but are not limited to, medical dictation transcription, spa treatments at a disparate collection of spa boutiques, valet car cleaning at a disparate collection of car parks, and the like.

In the following detailed description, references are made to the accompanying drawings that form a part hereof, and in which are shown by way of illustration specific embodiments or examples. Referring now to the drawings, in which like numerals represent like elements throughout the several figures, aspects of a computing system, computer-readable storage medium, and computer-implemented methodologies for cross-store licensing for third party products and other aspects will be presented.

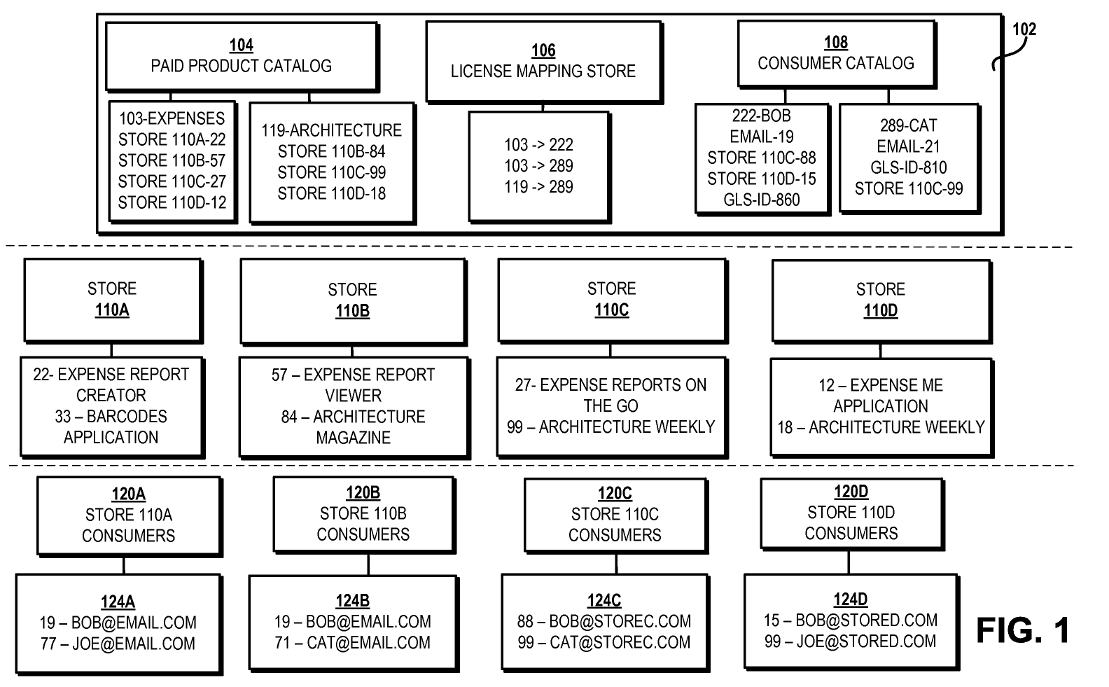

Referring now to the figures, FIG. 1 is an overview of a global licensing service 102. Various aspects of the global licensing service 102 provide a central licensing service to map purchases of products by a consumer across multiple stores. Further aspects of the global licensing service 102 may provide a better transactional experience for consumers by removing inter-store product purchasing friction. Other aspects of the global licensing service 102 may enable developers of third party products to use the licensing services provided by the global licensing service 102 to sell products across multiple stores, to track payments of those products and to track usage of those products across different platforms and devices. As used herein, a “third party” means a developer not associated with or working on behalf of the provider of a particular store. A provider of a particular store, which may be called a first or zero party in that store, may be a third party in a stored provided by another entity. The concepts and technologies described herein are not limited to any particular designation of an entity. The use of the term “third party” is for purposes of illustration and convenience only and does not limit the scope of the presently disclosed subject matter.

The global licensing service 102 includes a paid product catalog 104, a license mapping store 106 and a consumer catalog 108. The paid product catalog 104 is a data store that has stored therein global product identifiers for various products sold in one or more stores 110. For example, a product entitled “expenses” may have a store-specific identification of “22” in a Store 110A, “57” in a Store 110B, “27” in a Store 110C, and “12” in a Store 110D (hereinafter the Store 110A-110D are referred to collectively and/or generically as “the stores 110”, or, individually as “the Store 110A,” “the Store 110B,” and so forth). The paid product catalog 104 may map the various product identifications of the “expenses” product to the global product identifier “103” of the “expenses” product. In a similar manner, a product entitled, “architecture” may have a store-specific identification of “84” in the Store 110B, “99” in the Store 110C and “18” in the Store 110D. Examples of stores 110 may include, but are not limited to, the ITUNES application store provided by Apple Inc. of Cupertino, Calif., the GOOGLE PLAY application store provided by Google, Inc. of Mountain View, Calif., and the WINDOWS and OFFICE stores provided by Microsoft Corporation in Redmond, Wash. The presently disclosed subject matter is not limited to any particular store. A further example of the stores 110 may be stores setup and run by a developer. The stores 110 may be a website run by the developer to facilitate the purchase of one or more products developed and offered for sale by the developer.

It should be appreciated that one or more of the stores 110 may use various types of identifiers for products, such as the product entitled “architecture.” In the example, illustrated in FIG. 1, the product entitled “architecture” may be associated with the number identified hereinabove or a title in one or more of the stores. For example, the product entitled, “architecture” may have a store-specific identification of “84” in the Store 110B, but may also be identified as “Architecture Magazine.” The presently disclosed subject matter is not limited to any particular manner of identifying products.

Although there may be various reasons for using a global product identifier, one reason may be that the same product, or components of the product, may have different titles in different stores. For example, the “expenses” product, which has a global product identifier of “103” is related to or is the product entitled “expense report creator” in the Store 110A, “expense report viewer” in the Store 110B, “expense reports on the go” in the Store 110C and “expense me application” in the Store 110D. In a similar manner, the “architecture” product, which has a global product identifier of “119” may be entitled “architecture magazine” in the Store 110B and “architecture weekly” in both the Store 110C and the Store 110D.

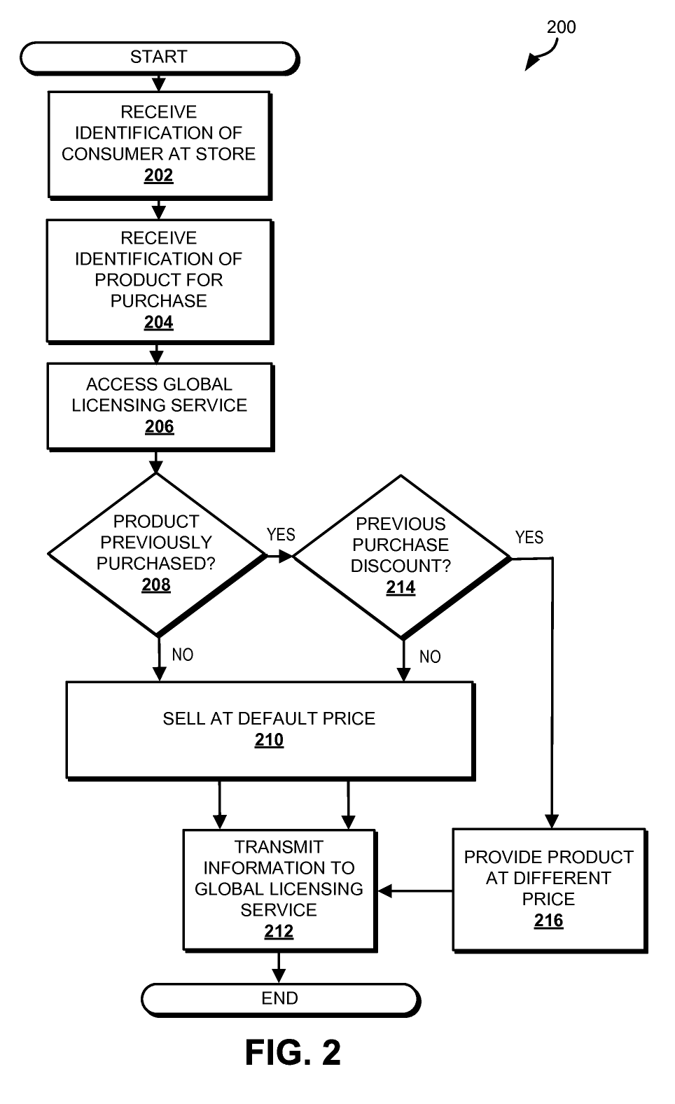

In addition to providing a map of the same product, a global product identifier may also map various components or related products to a single product designation in the paid product catalog 104. In FIG. 2, the product entitled, “expenses” is mapped to the product entitled “expense report creator” in the Store 110A, “expense report viewer” in the Store 110B, “expense reports on the go” in the Store 110C and “expense me application” in the Store 110D. Instead of selling the same product in the various stores, a developer may offer for sale different versions of the same product or different products that relate to each other. For example, the “22-expense report creator” product sold in the Store 110A may generate expense reports while the “57-expense report viewer” product sold in the Store 110B may provide a display of reports.

Each of these products may provide one or more services on various devices. For example, the “22-expense report creator” product sold in the Store 110A may be used on one device or may be used as a component in a software package used on various devices. In this example, the Store 110A may contain products intended for use in products that are part of the MICROSOFT OFFICE family of products from Microsoft Corporation in Redmond, Wash. Examples of these products are MICROSOFT WORD, MICROSOFT EXCEL, MICROSOFT POWERPOINT, MICROSOFT ACCESS, MICROSOFT VISIO, or MICROSOFT OUTLOOK families of application programs. The Store 110A may also contain products intended for use in products that are part of the GOOGLE DOCS family of products from Google, Inc. of Mountain View, Calif. These product family suites are merely exemplary and do not limit the scope of the presently disclosed subject matter to those particular suites.

The “57-expense report viewer” product sold in the Store 110B may be used on one or more devices running the WINDOWS operating system from Microsoft Corporation in Redmond, Wash. Other types of operating systems may be used and are considered to be within the scope of the present disclosure. The two products, the “22-expense report creator” and the “57-expense report viewer”, may be related products by the same developer and may be intended to work together or provide services to each other. For example, the “22-expense report creator” may be used by a consumer in an OFFICE product to create expense reports, while the “57-expense report viewer” may be used by a consumer in a non-OFFICE product to view the expense report created in the OFFICE product. While performing different functions, the two products together may form the “103-expenses” global product.

By mapping different but related products to the global product identifier “103”, the global licensing service 102 may be able to track related components across multiple stores and provide that information to a developer or one of the stores. For example, the related nature of the “expenses” products mapped to the global product identifier “103” may be used to provide incentives and discounts in one store when a related product is purchased in another store. The mapping of products to a global product identifier can provide different transactional experiences in the stores 110. A consumer may pay a price for the “12-expense me application” in the Store 110D and, when accessing the store 110C to pay for the “27-expense reports on the go” product, may receive a discounted price or even receive the product without payment.

In addition to products being mapped to a global product identifier, the global licensing service 102 may also map consumers 120 to a global consumer identifier. Shown in FIG. 1 are Store 110A consumers 120A, Store 110B consumers 120B, Store 110C consumers 120C, and Store 110D store consumers 120D (hereinafter the consumers 120A-120D are referred to collectively and/or generically as “the consumers 120”, or, individually as “the consumers 120A,” “the consumers 120B,” and so forth). There are three consumers 120, “Bob”, “Joe” and “Cat”.

The consumers 120 have different consumer identifiers associated with the stores 110. For the Store 110A and the Store 110B, “Bob” uses a store consumer identifier 124A entitled, “19-Bob@email.com” to access the services for the stores. To access and use the Store 110C, “Bob” uses a store consumer identifier 124C entitled, “88-Bob@storec.com”. And, to access and use the Store 110D, “Bob” uses a store consumer identifier 124D “15-Bob@stored.com”. Similarly, “cat” uses “71-cat@email.com” for the Store 110B and “99-cat@storec.com” for the Store 110C. “Joe” uses “77-Joe@email.com” for the Store 110A and “99-Joe@stored.com” in the Store 110D. Hereinafter, the store consumer identifier 124A-124D are referred to collectively and/or generically as “the consumer identifiers 124”, or, individually as “the store consumer identifier 124A,” “the consumer identifier 120B,” and so forth. The numbers in the above identifiers can be a numerical designation for the identifier. As mentioned briefly above in regard to the products, the consumers 120 may also be identified by either a number or text, or both. For example, Joe may be identified in the Store 110A as “77,” Joe@email.com, or 77-Joe@email.com. The present disclosure is not limited to any manner in which the consumers 120 may be identified.

In a conventional, fragmented system, the different identifiers used by the consumers 120 in the stores 110 may be interpreted as different consumers. For example, the identifier “Bob” uses in the Store 110C, “Bob@storec.com” may be interpreted as a different consumer than “Bob@email.com,” which is the identifier “Bob” uses to access the Store 110A and the Store 110B. Thus, purchases made by “Bob” in one of the stores 110 may not be connected with purchases made by “Bob” in a different store. This disconnect between the identifiers used to access the stores 110 and the actual consumers 120 can be a contributing factor to the fragmentation discussed above.

In a different manner, the global licensing service 102 provides a centralized consumer mapping service to map consumers 120 to their various identities used in the different stores. In the consumer catalog 108, the various identities for “Bob” have been mapped to the numerical designation of “222” and the various identities for “Cat” have been mapped to the numerical designation of “289”. Thus, activity involving the various identities for “Bob” or “Cat” can be mapped to one numerical designation. As is the case with the stores 110, the global licensing service 102 may also provide a global consumer identifier for the consumers 120. The global consumer identifier for “Bob” is “GLS-ID-860” and the global consumer identifier for “Cat” is “GLS-ID-810”. The consumers 120 may use this global consumer identifier in various ways, examples of which are provided in the description of various figures below.

Once the products have been mapped in the paid product catalog 104 and the consumers 120 have been mapped in the consumer catalog 108, the global licensing service 102 may map the paid product catalog 104 to the consumer catalog 108 in the license mapping store 106. The license mapping store 106 is a central location that provides a transactional mapping. The transaction mapping brings together the information provided by mapping the consumers 120 and products. An entity accessing the information in the license mapping store 106 may be able to view transactions of specific products made by specific consumers 120. For example, the license mapping store 106 shows that the product having the global product identification of “103,” which is the “expenses” product, has been purchased by consumers 120 having the identification of “222,” which is “Bob”, and “289,” which is “Cat.” Similarly, the license mapping store 106 has data showing that “Cat” has also purchased the product with the identification of “119,” which is the “architecture” product.

The combination of the paid product catalog 104, the license mapping store 106 and the consumer catalog 108 can provide various benefits that may help defragment a marketplace. For example, “Bob” may have purchased the 22-expense report creator” product in the Store 110A. The global licensing service 102 may receive information regarding that transaction, including the store-specific identification of the consumer, “19” and the store-specific identification of the product purchased, “22”. The global licensing service 102 receives that information and maps the consumer “19,” which is “Bob” to the identifications for “Bob” stored in the consumer catalog 108. The global licensing service 102 also maps the product identification “22” and stores that information in the paid product catalog 104. This information is mapped in the license mapping store 106, associating various identities of “Bob” with the various identities of the product, “expenses”.

The mapping provides a central repository of transactional information that may be used by other entities. For example, “Bob” may access the Store 110C to purchase the product “27-expense reports on the go.” The Store 110C may receive information from the global licensing service 102 that “Bob” has already purchased the “22-expense report creator” product in another store. If the store is configured as such, the Store 110C may adjust the price for the “27-expense reports on the go” product based on the previous transaction.

In one implementation, a developer of the “expenses” product may set forth one or more rules that the product bought in one store will cause a reduction in price in another store. A developer may also establish a payment structure in which the consumers 120, such as “Bob”, are offered two prices for products relating to the “expenses” product. The first price can be a standard price to purchase a product relating to the “expenses” product that does not provide any discounts, reductions in price, or other benefits to the consumers 120 in other devices or when purchasing an “expenses” product in another store. A second price may be a premium price that may give the consumers 120 additional benefits. This is illustrated by way of example in FIG. 2.

FIG. 2 is flow diagram illustrating an exemplary method 200 for determining the price of a product sold in one store based on a purchase by the consumer of the product in another store. It should be understood that the operations of the method 200 and other methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims. It also should be understood that the illustrated methods can be ended at any time and need not be performed in their entirety.

Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

Turning to FIG. 2, the method 200 begins at operation 202, where the identification of a consumer is received at an application store. As discussed above, the consumer may have established a store-specific identification for use in the store. In some configurations, the consumer may use a global consumer identifier as described above. The configuration of FIG. 2 is not limited to any particular consumer identifier.

From operation 202, the method 200 proceeds to operation 204, where the identification of the product the consumer wishes to purchase is received. As with the identification associated with the consumer, the concepts described herein are not limited to an identification provided by any particular source, including one of the stores 110 or the global licensing service 102. The product “103-expenses” may have one or more related components for sale in the stores 110, some of which include the “22-expense report creator” sold in the Store 110A and the “57-expense report viewer” sold in the Store 110B.

From operation 204, the method 200 proceeds to operation 206, where the global licensing service 102 is accessed. There may be various reasons for accessing the global licensing service 102. For example, the method 200 is an exemplary method for determining a price of a product based on transaction information. Because the consumer accessing the particular store may have purchased the product or associated products in other stores with different identifications, the store may not have a complete record of transactions involving the consumer and the product identified in operation 204.

As discussed above, various implementations of the global licensing service 102 provide a centralized repository of information, including one or more data stores that maps the product selected at operation 204 with different product identifications in other stores. The global licensing service 102 may also provide transactional information relating to the consumer and the product selected in operation 204. In some configurations, the store may not be granted access to the consumer catalog 108 due to, among others, security reasons. It may be undesirable to provide one store with the identifiers of the consumer in another store.

The method 200 proceeds from operation 206 to operation 208, where a determination is made as to whether or not the product has been previously purchased by the consumer. Once the global licensing service 102 is accessed in operation 206, the store may retrieve information from the license mapping store 106 of the global licensing service 102. The license mapping store 106 can map the different identities of a consumer with one or more products purchased by the consumer. By accessing the global licensing service 102, the store can retrieve pricing information relating to the product identified in operation 204. The pricing information may be provided by the global licensing service 102. In some implementations, the global licensing service 102 may not have access to the pricing information. In those implementations, the stores 110 may have information provided by the developer to the stores 110.

In the alternative, the pricing may be a determination as to whether or not the price information known to the store should be modified. As discussed briefly above, the price of a particular product may depend on whether or not a transaction previously occurred involving the product and the consumer. The consumer may have purchased the product in a different store, and therefore, should be provided the product at no extra cost. In another example, the consumer may have purchased the product at a premium, and therefore, subsequent purchases of the product may be at a discounted rate, including a full discount. In a further example, the consumer may have to purchase the product in the second store but may receive credit in a different form.

Another form may be an in-product consumable such as, but not limited to, a certain number of uses of a text effect feature, a certain number of annotations to an architectural diagram, and the like. Another form may be durables such as, but not limited to, additional cloud storage space, additional product capabilities, and the like. As used herein, an “in-product purchase” or an “in-application” purchase refers to a purchase facilitated by the product or the application.

If, at operation 208, it is determined the product was not previously purchased, the method 200 proceeds to operation 210, where the product is sold in the store at a default price. The default price may be the price established by a developer of the product upon submission of the product to the store for purchase. The default price may also be the price provided to the store by the global licensing service 102. The concepts described herein are not limited to any particular source of product and may include other sources not designated herein.

The method 200 continues from operation 210 to operation 212, where the license information is transmitted to the global licensing service 102. The transaction information may be used by the global licensing service 102 to provide information relating to the consumer or the product in subsequent transaction with the store or other stores. The performance of operation 212 may help increase the information available in the global licensing service 102 to the store or other stores. As such, the transmission of the transactional data may help reduce the level of defragmentation in the marketplace. The method 200 thereafter ends.

Returning to operation 208, if the determination was that the product was previously purchased by the consumer, the method continues from operation 208 to operation 214, where a determination is made as to whether or not a discount is available based on the previous purchase. As mentioned above, prior purchases of the product by the same consumer may provide the consumer with the benefit of reduced pricing. If the prior purchase does not warrant a discount, the method 200 proceeds from operation 214 to operation 210 and continues in the manner described immediately above.

If the previous purchase does warrant a discount, the method 200 proceeds from operation 214 to operation 216, where the price of the product is provided at the discounted price. The discounted price may be a lower price or, depending on the pricing model, may be provided without a cost to the consumer. The lower or different price may be established by various entities such as, but not limited to, the developer, the global licensing service 102, the product itself, a separate pricing service (not illustrated), and the like. The present disclosure is not limited to any particular source of pricing changes or any particular price change methodology. The transaction information is transmitted to the global licensing service 102 at operation 212 and the method 200 ends thereafter. In one implementation, if a second purchase is required and is consummated, the licensing mapping information stored in the license mapping store 106 may be augmented with details of the second transaction. In this implementation, the licensing mapping store 106 may store not on the fact that the consumer purchased the product, but also, more granular information such as from which store a purchase was made, was the purchase a basic or premium purchase, was the purchase a subscription to a renewable product, and the like.

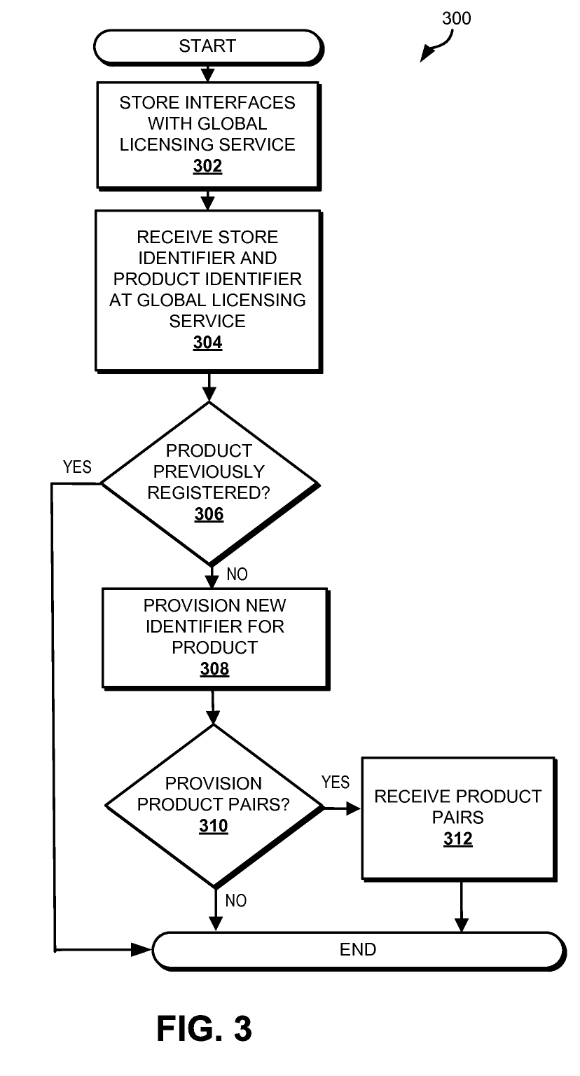

FIG. 3 is a flow diagram showing an exemplary method 300 for registering a new product in the global licensing service 102. The method 300 is a registration process involving a store and the global licensing service 102. In some configurations, a developer may also register a product directly with the global licensing service 102, as will be discussed in further detail below.

The method 300 begins at operation 302, where a store interfaces with the global licensing service 302. The store may be the Store 110A, the Store 110B, the Store 110C, and the Store 110D. It should be understood, however, that the present disclosure is not limited to the stores 110 illustrated herein. The store may have received a product from a developer for sale in the store. The store may interface with the global licensing service 102 to register the product.

The method 300 proceeds from operation 302 to operation 304, where the global licensing service 304 receives the identification of the store and the store-specific product identification for the product. The store-specific product identification, such as “22” in the Store 110A for the product “expense report creator”, may provide information to map the store and the product to various other products. It should be noted that the present disclosure may not require the store identification, but to provide certain auditing or informational services, the store identification may be useful. For example, as discussed briefly above, a developer may access the paid product catalog 104 to determine the sales of their particular product. Without the store identification, the sales numbers may be raw numbers that may be difficult to trace to a specific store. By providing the store identification, transactions for a particular product may be associated with a particular store.

The method 300 proceeds from operation 304 to operation 306, where a determination is made as to whether or not the product has been previously registered. If the product has been previously registered, the method 300 proceeds from operation 306 to end. If the product has not been previously registered, the method 300 proceeds from operation 306 to operation 308, where a new identifier is provisioned for the product. The product may have one or more identifications provisioned that allow the mapping of transactions involving the product across the stores 110.

One example of an identifier may be a global licensing service identifier. As illustrated in FIG. 1 by way of example, the product “expenses” has been associated with the global product identifier “103”. In reference to the paid product catalog 104 of FIG. 1, each of the stores 110 has a unique identifier for the product “expenses”. The “expenses” product has an identifier of “22” in the Store 110A, “57” in the Store 110B, “27” in the Store 110C, and “12” in the Store 110D. At least some, if not all, of these store-specific identifiers are associated with global product identifier 103 provisioned by the global licensing service 102 in operation 308.

The method 300 proceeds from operation 308 to operation 310, where a determination is made as to whether or not the product has been paired by the developer. An example of a pairing may be the association of a particular store with the store-specific identification for the product. A developer can provide information the developer receives from a particular store about a particular product. For example, the global licensing service 102 may receive an input from a developer that the Store 110A has provisioned the identification of “22” for the “expenses” product. If the global licensing service 102 is configured to receive this data, from the developer or another source, the method 300 proceeds from operation 310 to operation 312, where the global licensing service 102 receives and stores the pairing information. The method 300 ends thereafter. If the global licensing service 102 is not configured to receive pairing data, the method 300 proceeds from operation 310 to end.

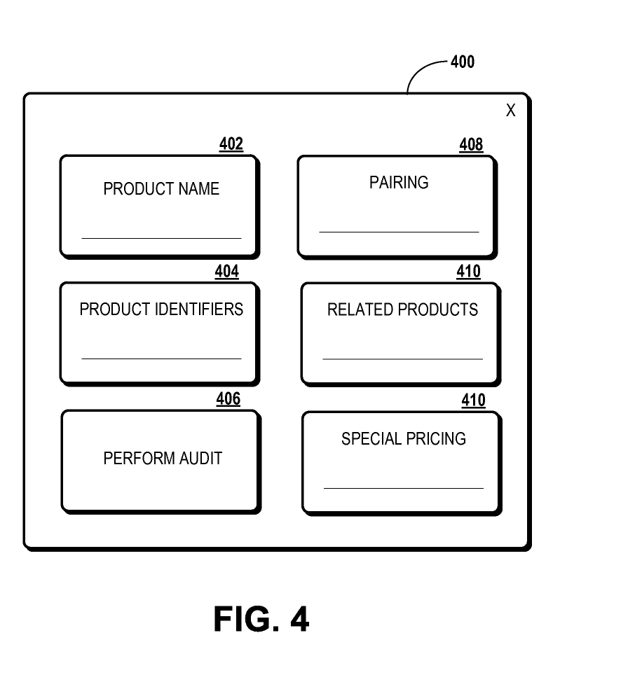

FIG. 4 is an exemplary developer UI 400 for receiving various inputs from a developer. As discussed briefly above, a developer or supplier of a product may submit various pieces of information to facilitate the mapping of the product in the global licensing service 102. The developer UI 400 may be initiated when a developer logs into one of the stores 110 when submitting a product for sale or the global licensing service 102 in conjunction with the registration of a product, as well as other examples. Because of the information being submitted, in some configurations, the developer UI 400 may be provided by way of a secure network connection. It should be understood, however, that the developer may be provided with other interfaces, such as a developer dashboard that directly integrates with the global licensing service 102, or a developer data web service that may provide programmatic querying of data as well as construction of a web interface.

The entity providing the developer UI 400 may use, by way of example and not by way of limitation, a secured network connection between the developer, the global licensing service 102 and the store. In one example, a store that directly integrates with the global licensing service 102 may host the developer UI 400, whereby, a store that does not directly integrate with the global licensing service 102 may direct the consumer to a secure website hosted by the global licensing service 102 to perform similar functions as the developer UI 400.

The developer UI 400 may include one or more UI controls from which the entity initiating the developer UI 400 may receive data from the developer. It should be noted that the controls described herein are merely illustrative. The technologies described herein are not limited to any particular control or data received from a developer. One exemplary control is a product name control 402. In the product name control 402, data including the name of a product may be received from the developer. In some configurations, the name of the product may not be required, as the identifiers provided by the stores 110 or the global licensing service 102 may be sufficient to map the product to transactions involving various consumers.

Another exemplary control may be the product identifier control 404. In the product identifier control 404, the developer may enter identifiers known of the product known to the developer. For example, if the developer has already submitted the product to a particular store, the developer may know the identifier generated by the store for the product in the store. This may obviate the need for the global licensing service 102 to search for and retrieve the identification from the store. The product identifier control 404 may allow the developer to enter one or several identifiers. In some configurations, the product identifier control 404 may allow the developer to designate an identifier for the product.

In another implementation, the need to directly register the products' identifiers in the stores 110 may be removed. In this implementation, the developer may be provided with the global identifier for their product. In use, the developer may perform an in-application check within the application to determine if the consumer had purchased the product in another store. But, rather than using a product identifier provided by the store, the developer may use the global product identifier provided by the global licensing service 102.

A further exemplary control is the audit control 406. As discussed above, the paid product catalog 104 may provide a centralized data store of transactional information involving a particular product. The number of times the product is sold in one of the stores may be stored in the paid product catalog 104. The developer may wish to perform an audit on the sales of the product across various stores. The paid product catalog 104 may be a convenient, single location to perform the audit instead of the developer accessing databases for each of the stores 110 and compiling the information. When selected, the audit control 406 may provide the developer with sales information of the product across the stores 110. The information may be incomplete if one or more of the stores 110 does not submit up-to-date sales information.

A still further example of a control may be the pairing control 408. As discussed above in regard to FIG. 3, the developer may want to pair the product with a particular store. Although the global licensing service 102 may be configured to determine the information, the pairing control 408 may provide a mechanism whereby the developer, not the global licensing service 102, determines the pairs. Other types of pairing may be the association of the product with other products. A related products control 410 may provide the developer with a mechanism to submit the identifications of products associated with the product being submitted.

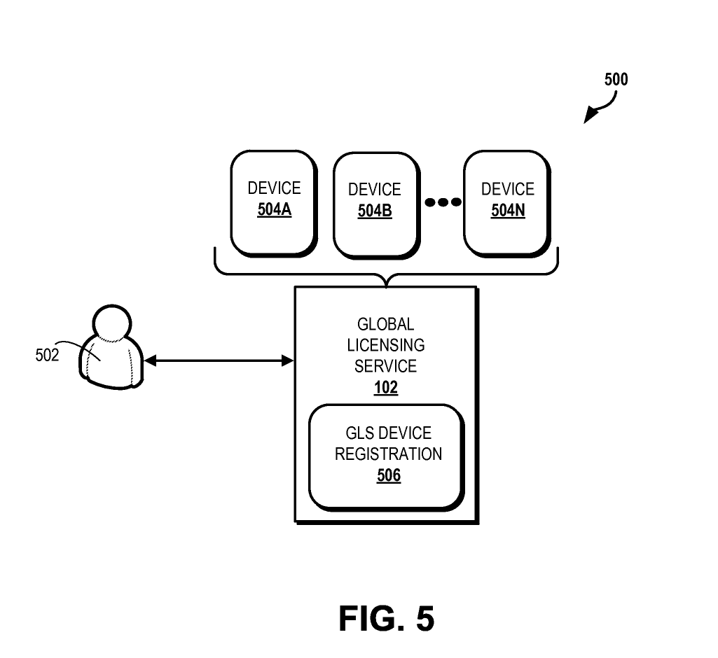

The developer UI 400 may also include a special pricing control 410. The special pricing control 410 may allow a developer to input various pricing models into the global licensing service 102. An example mentioned above is a premium/default pricing model. In this model, a consumer may be presented with two pricing options for the purchase of a product. One option may be to pay the default amount, which gives the consumer the right to use a single instance of a product. The other option may be to pay a premium price. In this pricing model, the consumer may pay more than the default price, but instead of only receiving the right to one instance of a product, the consumer may be able to access other stores and download the product from those stores. In another implementation, the premium price may allow the consumer to download the product on multiple devices registered to the consumer, illustrated by way of example in FIG. 5, below.

FIG. 5 is a system diagram showing an exemplary system 500 in which a consumer 502 may register multiple devices 504A-504N (hereinafter the devices 504A-504N are referred to collectively and/or generically as “the devices 504”, or, individually as “the device 504A,” “the device 504B,” and so forth). The consumer 502 may wish to register the devices 504 with the global licensing service 102 for various reasons. The consumer 502 may want to map the devices 504 to provide for a more efficient transactional experience involving the devices 504. For example, the consumer 502 may want to download products purchased for a device onto other devices 504. By registering the devices 504 with the global licensing service 102, the consumer 502 may need to simply identify to which of the devices 504 the product should be downloaded. Further, in an effort to reduce the unauthorized duplication and sharing of products, the consumer 504 may be required to register the devices 504 in order to receive permission to operate the product on one or more of the devices 504.

To provide for the registration of the devices 504, the global licensing service 102 may include a GLS device registration control 506. The consumer 502 may access the GLS device registration control 506 and submit information relating to the devices 504. In some implementations, the information regarding the devices 504 may be specific to the device itself. For example, the device 504A may be a wireless mobile device. The unique identifier may be the international mobile subscriber identity (IMSI) assigned to that device. In another example, the device 504B may be a tablet computer. The unique identifier for the device 504B may be the serial number of the tablet computer, the MAC address, and the like. It should be understood, though, that that in some implementations of the presently disclosed subject matter, even without registering the devices 504, the consumer 502 may access the stores 110 and purchase products offered in the stores 110. It should be appreciated that the disclosure provided herein is not limited to manual device registration, as some devices 504 may be configured to auto-register. For example, the devices 504 may auto-register when the consumer is signed into the device with an identity recognized by the global licensing service 102 or a store that integrates with the global licensing service 102.

During a transaction in which the consumer 502 is purchasing a product or at periodic intervals, products previously purchased by the consumer may be downloaded to the devices 504 registered with the global licensing service 102. For example, while facilitating a transaction, a store may receive the identification of one or more devices 504 that are registered. The identification may come from various sources, including the consumer or the global licensing service 102. Upon receipt of the identification of the one or more devices 504, the store may download the purchased product to the devices 504. In another implementation, the download may be initiated by the global licensing service 102. For example, the global licensing service 102 may receive a notification that a product was purchased and downloaded to one of the devices 504. The global licensing service 102 may then, without input or prompt from the consumer 502 or a store, download the product to the other devices 504. In some implementations, the global licensing service 102 may download the product to the other devices 504 upon notification of a transaction or periodically to synchronize the products on the devices 504. In some configurations, the global licensing service 102 may also download updates, security patches, or new features.

As part of the global licensing of products, the mapping of consumers to products purchased may need to be established. In one configuration, this mapping may be established when the consumer first purchases the product. In subsequent transactions, this mapping may be used to determine the parameters of the transactions. In some configurations, a store may natively integrate with the global licensing service 102. In other configures, a store may not be integrated with the global licensing service 102.

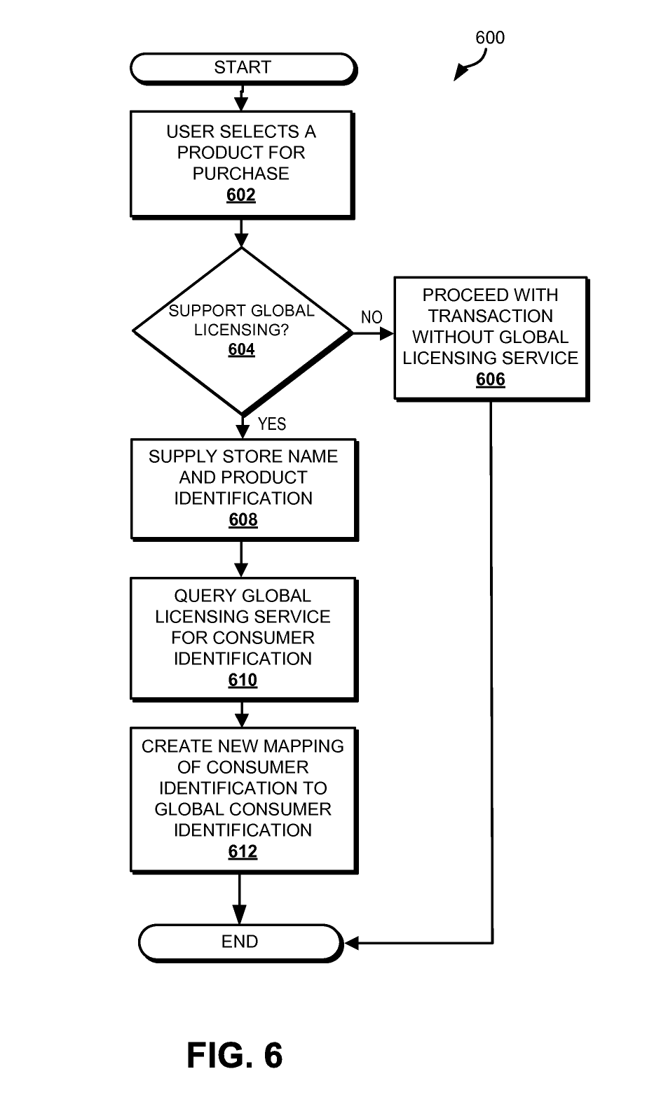

FIG. 6 is a flow diagram showing an exemplary method 600 for processing a transaction involving a store that is natively integrated with the global licensing service 102. The method 600 begins at operation 602, where an input is received in a store 110 that a consumer has selected a product for purchase. The product can include, but is not limited to, an application, a service, a periodical, and the like. In some configurations, the consumer will log into a store 110 offering the product for sale using a store-specific identification. In other configurations, the consumer may log into the store 110 using an identifier such as the global consumer identifier. The present disclosure is not limited to any particular login criteria.

The method 600 proceeds from operation 602 to operation 604, where a determination is made as to whether or not the product supports global licensing. In some configurations in which the store 110 is fully integrated natively with the global licensing service 102, the store 110 may have direct access to the paid product catalog 104 and may not need to request a communication link. In other configurations, the store 110 may be integrated but may still require the initiation of a communication link between the store 110 and the global licensing service 102. In these and other configurations, the communication will typically be a secure communication.

For example, the communication may incorporate the use of a certificate-checking technology to verify the authenticity of the store 110. During the integration of the store 110 with the global licensing service 102, the store 110 may be issued a certificate. When accessing the ‘global licensing service 102, the store 110 may be required to use the certificate to access various resources of the global licensing service 102. It should be understood, however, that the present disclosure is not limited to the requirement of a secure connection, nor limited to any particular security method.

In some configurations, the product itself may provide the information necessary to determine whether or not the product supports global licensing. For example, the product may have metadata associated with the product that indicates that the product supports global licensing. Another configuration may be data provided by the developer that submitted the product to the store 110 for purchase. These and other configurations are considered to be within the scope of the present disclosure.

If the product does not support global licensing, the method 600 proceeds from operation 604 to operation 606, where the transaction in the store 110 proceeds in a manner local to the store 110. For example, the store 110 may utilize pricing, licensing, or distribution information available to the store 110 locally to consummate the transaction with the consumer. The method 600 proceeds from operation 606 to end.

If, at operation 604, it was determined that the product does support global licensing, the method 600 proceeds from operation 604 to operation 608, where the global licensing service 102 receives the name of the store 110 or a store identification as well as the identification of the product. The information submitted pursuant to operation 608 can be used to retrieve a global product identifier for the product. Depending on the information available to the global licensing service 102, the store identification may not be required. If the store 110 is natively integrated, when the communication link between the store 110 and the global licensing service 102 is established, the store identification may be determined pursuant to the connection.

The method 600 proceeds from operation 608 to operation 610, where the store 110 queries the global licensing service 102 for a global consumer identifier for the consumer wishing to make the purchase. In some configurations, the query is to determine whether or not there is a global consumer identifier for the consumer pair, such as the store name and the consumer identifier used to log into the store 110. In some implementations, the consumer identifier includes a service provider, such as an email service provider, and the service provider's unique identifier for the consumer. If not already established, the global licensing service 102 will create a new global consumer identifier and associate that identifier with the store 110 and product.

The method 600 proceeds from operation 610 to operation 612, where a new map of the global consumer identifier to the global service identifier is created. This map can be used by the store 110 or other stores in subsequent transactions involving the consumer and the product. When a consumer submits information that indicates that the consumer wishes to purchase the product in a different store, perhaps for another device, the different store may access the global licensing service 102 to determine if the consumer has any benefit from previous purchases. The map created in operation 612 may assist the different store in determining the parameters of the transaction. The method proceeds from operation 612 to end.

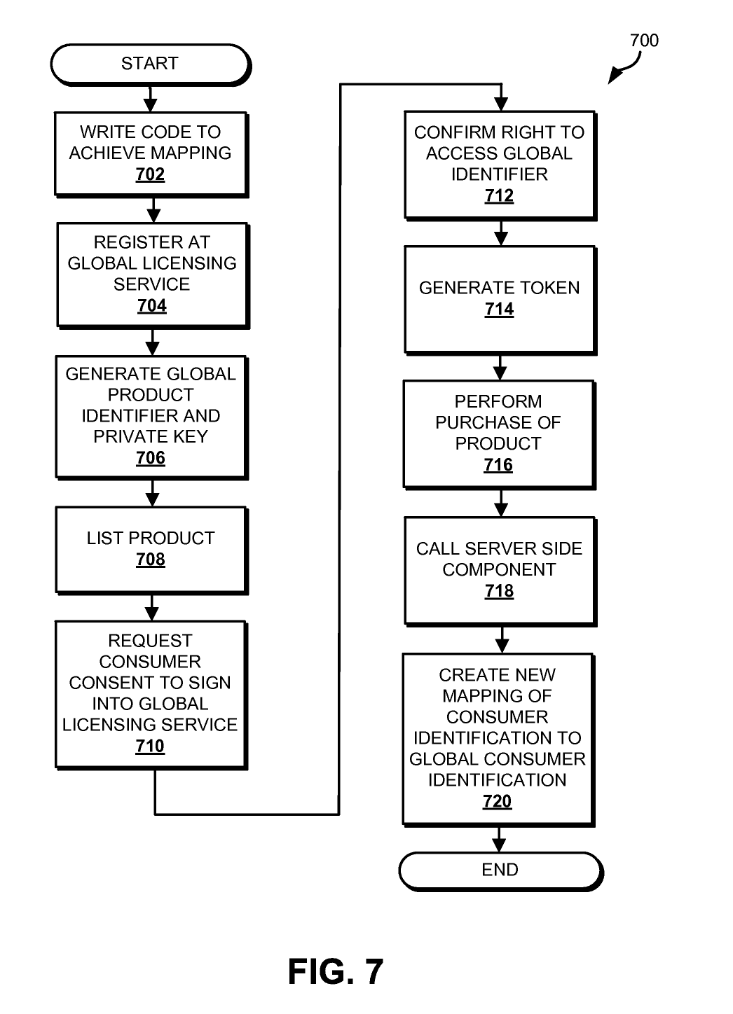

FIG. 7 is a flow diagram showing an exemplary method 700 that may be used if a store is not natively integrated with the global licensing service 102. The method 700 begins at operation 702, where the developer writes code to facilitate the mapping. A challenge may be to ensure that the creation of the consumer/product mapping is done in a way that reduces the probability of tampering. For example, a consumer may illegitimately create a consumer/product map for themselves or another person or entity to receive the product at a discount or for free. Thus, the method 700 may include operations that are designed to create a verification system in which a legitimate map of a consumer/product may be created, while making it difficult for illegitimate maps to be created. In one implementation, the developer may maintain a portion of the code on the developer's computer rather than in the code of the application that is downloaded to the consumer's device, to reduce the likelihood of tampering.

The method 700 proceeds from operation 702 to operation 704, where the developer registers the product at the global licensing service 102. There may be various ways in which the developer may register their product with the global licensing service 102. An example was provided above in relation to FIG. 4. FIG. 4 included a developer UI 400 having several controls that the developer may use to submit information.

The method 700 proceeds from operation 704 to operation 706, where a global product identifier and a private key associated with the product are generated. Examples of the global product identifier are provided in FIG. 1, above. The examples are “103” for the “expenses” product and “119” for the “architecture product.” The private key may be used by the global licensing service 102 to verify various aspects of the transaction, as will be discussed in various figures below.

The method 700 proceeds from operation 706 to operation 708, where the product is listed at a predetermined, or default, price in the store 110 performing the transaction. In some configurations, the product may be listed as free in the store 110. The product may be listed as free in the store 110, but to access the product, there may still be a requirement to perform a purchase such as, but not limited to, an in-application purchase. In some cases, the product may be listed as free, but require in-product purchase. While the product may be listed as paid (with a trial), a problem may result in that the store may keep prompting the consumer to buy the product at the default price. In these configurations, the store may list the product as being free rather than paid.

The method 700 proceeds from operation 708 to operation 710, where the global licensing service 102 prompts the consumer to sign in to the global licensing service 102 using an identification known to the global licensing service 102, such as the global consumer identifier. In one implementation, if the product can programmatically retrieve the current consumer's identifier, such as the customer identifier for bob@email.com, for the current store, such as the store 110B, the global licensing service 102 may securely transmit the consumer's ID, such as the numerical representation of the customer identifier with the provider name. In some implementations, an open authentication system may be used, such as an OAuth path. For example, the global licensing service 102 may register with a social network. The consumer may sign into their account on the social network. Thereafter, the social network may send the consumer identifier to the global licensing service 102.

The method 700 proceeds from operation 710 to operation 712, where the consumer is prompted to confirm that the consumer gives permission to access the consumer's identity from the global licensing service 102. In some configurations, the product may perform this operation 712. In another configuration, the store may perform this operation 712.

The method 700 proceeds from operation 712 to operation 714, where a token, such as an access or mapping token, is generated. In some configurations, the token is provided to the store if the store is performing various operations of the method 700. In another configuration, the token may be granted to the product if the product is performing various operations of the method 700. In some configurations, the token includes the global product identifier and the global consumer identifier. In some configurations, the token may be a secure key that the product or store uses to programmatically alter the querying and mapping between that global product identifier and global consumer identifier. In some implementations, the token may also include the state of a license prior to any new transaction, such as whether or not a consumer as already purchased the product in another store.

The method 700 proceeds from operation 714 to operation 716, where the consumer will sign into the store 110 using the consumer's identifier associated with the store 110 and complete a purchase of the product. In a variation of the method 700, described by way of example in FIG. 2, if the consumer has previously purchased the product and if the developer or store permits the product to be purchased for free in such cases, the method 700 may end. If not, then a receipt for the transaction may be generated by the store and associated with the product.

The method 700 proceeds from operation 716 to operation 718, where a server-side component, such as a website run by the developer, is called using the token and the receipt. The server-side component may confirm the validity of the receipt with the store 110 and securely call the global licensing service 102 using the identifier of the store 110, the private key, and the token.

The method 700 proceeds from operation 718 to operation 720, where the global licensing service 102 verifies the token and looks up the global product identifier associated with the private key. The global licensing service 102 then creates a mapping between the global consumer identifier and a newly provisioned global consumer identifier. For example, in FIG. 1, the global consumer identifier of “222” associated with “Bob” may be mapped to a newly provisioned global consumer identifier. The method 700 proceeds to end from operation 720.

In some configurations, the access of the server-side component of operation 718 may be eliminated. The method 700 may be modified so that product requests the consent of the consumer using the product's public key. The global licensing service 102 requests that the consumer grant permission for the product to establish the global licensing. Upon receipt of the grant, a new global consumer identifier is created and the global licensing service generates a token. The product guides the consumer through the purchasing process using the consumer's store-specific identifier. The product can then send the receipt and the token to the global licensing service 102. The global licensing service 102 verifies the receipt and the token. The global licensing service 102 retrieves from the receipt the consumer's store-specific identifier and determines the global product identifier the developer registered for the product. The global licensing service 102 may then create a new entry to map the global consumer identifier to the global product identifier.

Upon the creation of the mapping of the consumer with the product in the global licensing service 102, the consumer may want to receive the product in another store at a discounted price or for free. Various aspects of the concepts described herein may automatically distribute the product to the consumer on various devices from different stores or the same store.

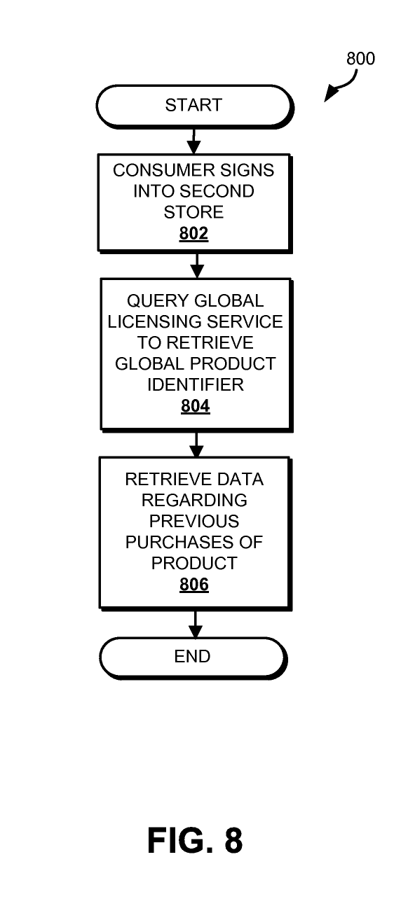

FIG. 8 is a flow diagram showing an exemplary method 800 for providing a product at one store that was previously purchased in another store. The stores in the configuration illustrated in FIG. 8 are natively interfaced with the global licensing service 102. The method 800 begins at operation 802, where the consumer signs into the second store and selects a product for purchase. The method 800 proceeds from operation 802 to operation 804, where, upon receipt of the selection by the consumer, the product or the store queries the global licensing service 102 to retrieve the global product identifier for the product. The method 800 proceeds from operation 804 to operation 806, where data is retrieved regarding previous purchases of the product made by the consumer. The data may be retrieved by using the global product identifier and the consumer identifier used when signing into the store.

In some configurations, if the consumer has paid for the product in the first store, the product may be provided for free or at a discounted price. In some configurations, the global licensing service 102 may transmit a notification to the consumer informing the consumer of other stores in which the consumer is entitled to receive the product upon completion of the initial transaction in the first store. In other configurations, the developer of the product may receive notification that a consumer has completed a transaction in which other products may be received as a result of the completion of the transaction. The developer may then be able to contact the consumer directly to provide information regarding other stores or locations in which other products may be received as a result of the completion of the transaction.

In still further configurations, if the consumer has received the rights to use the product in the first store, the rights to the product may be provided to one or more individuals or may be delegated from the consumer to the one or more individuals. For example, the global licensing service 102 or another entity may transmit a notification to one or more individuals that the consumer has received the right to the product. The one or more individuals may thereafter use information in the notification to receive access to the product or another product. In a still further configuration, the consumer may receive the notification and thereafter transmit information to one or more individuals so those one or more individuals can receive the product or another product.

In another configuration, the product may function in a limited manner until subsequent payment is received. For example, the product may include a certain number of uses, such as a number of reports that may be generated, or certain features, such as editable versus non-editable reports. The method 800 continues from operation 806 to end.

In some configurations, the global licensing service 102 or one or more of the stores 110, or another entity, may automatically download products previously purchased on one device to other devices registered by the consumer. For example, a store may receive a list of products the consumer has previously purchased. The list may be periodically updated by the store querying the global licensing service 102, or in an alternative configuration, the global licensing service 102 may automatically update stores integrated with the global licensing service 102. In some configurations, the store may receive a product from another store for access by the consumer when the consumer is logged into the store.

In some configurations, the consumer may be prompted to access a website if the consumer wishes to download the product to other devices if the consumer purchased the product at a store. At the website, the consumer may use their store-specific identifier or the global consumer identifier to access the website to download the product. The global licensing service 102 may map the various identifiers associated with the consumer and the global product identifier. The store may then query the global licensing service 102 to retrieve a list of all products paid for by the consumer. This information may then be used by the store to determine which products should be provided to the consumer at a discount or free basis.

At this point, a flow is enabled which allows the consumer to sign-in to get use of a product on a second device. Further enhancements can be made to provide increased security, such as the prevention of username and password sharing. For example, certain stores may record the hardware signature of the device where a product is installed. For stores which support the global licensing service 102 natively, the stores can pass up the hardware signature at the time the initial store global consumer identifiers/store-specific consumer identifiers mapping is accessed.

The global licensing service 102 can return data indicating the number of unique hardware signatures that exist for a given store consumer identifier, and the store can use this to gate access to the products. Alternately, if the consumer signs in with the global licensing service 102, the global licensing service 102 may record the last time the consumer signed in with this identifier. If there are too many concurrent sign-ins in a given time-period, further access may be blocked.

For paid services, various implementations of the disclosure herein may periodically query the global licensing service 102 to determine products that have been purchased by a consumer. Further the global licensing service 102 may periodically determine if the consumer no long has the right to use a product, such as by determining the validity of a license associated with the product. For example, the consumer may have purchased a certain number of instances of product, a subscription to a service that is canceled, or a license that is subsequently revoked due to refunds or fraud checks. The stores 110 may periodically transmit rights information to the global licensing service 102. If the consumer no longer has the right to use the product, the global licensing service 102 may store an expiration notification. The expiration notification may be used by the stores 110 or by the product to determine if the consumer has rights to the product.

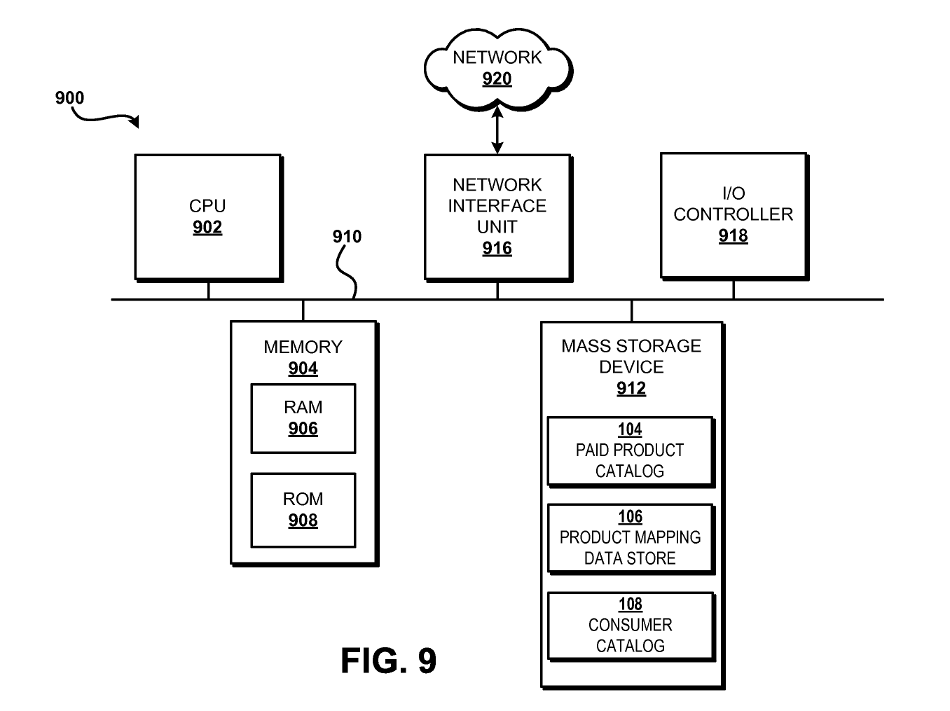

FIG. 9 is an illustrative computer architecture 900 for a device capable of executing the software components described above. Thus, the computer architecture 900 illustrated in FIG. 9 illustrates an architecture for a server computer, mobile phone, a PDA, a smart telephone, a desktop computer, a netbook computer, a tablet computer, and/or a laptop computer. The computer architecture 900 may be utilized to execute any aspects of the software components presented herein. For example, the computer architecture 900 may be used to implement the global licensing service 102.

The computer architecture 900 illustrated in FIG. 9 includes a central processing unit (“CPU”) 902, a system memory 904, including a random access memory 906 (“RAM”) and a read-only memory (“ROM”) 908, and a system bus 910 that couples the memory 904 to the CPU 902. A basic input/output system containing the basic routines that help to transfer information between elements within the computer architecture 900, such as during startup, is stored in the ROM 908. The computer architecture 900 further includes a mass storage device 912 for storing the paid product catalog 104, the license mapping store 106 and the consumer catalog 108 of FIG. 1.

The mass storage device 912 is connected to the CPU 902 through a mass storage controller (not shown) connected to the bus 910. The mass storage device 912 and its associated computer-readable media provide non-volatile storage for the computer architecture 900. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 900.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium that can be used to store the desired information and which can be accessed by the computer architecture 900. For purposes of the claims, the phrase “computer storage medium,” and variations thereof, does not include waves or signals per se and/or communication media.

According to various embodiments, the computer architecture 900 may operate in a networked environment using logical connections to remote computers through a network such as a network 920. The computer architecture 900 may connect to the network 920 through a network interface unit 916 connected to the bus 910. It should be appreciated that the network interface unit 916 also may be utilized to connect to other types of networks and remote computer systems. The computer architecture 900 also may include an input/output controller 918 for receiving and processing input from a number of other devices, including a keyboard, mouse, or electronic stylus. Similarly, the input/output controller 918 may provide an output to a display screen, a printer, or other type of output device.

It should be appreciated that the software components described herein may, when loaded into the CPU 902 and executed, transform the CPU 902 and the overall computer architecture 900 from a general-purpose computing system into a special-purpose computing system customized to facilitate the functionality presented herein. The CPU 902 may be constructed from any number of transistors or other discrete circuit elements, which may individually or collectively assume any number of states. More specifically, the CPU 902 may operate as a finite-state machine, in response to executable instructions contained within the software modules disclosed herein. These computer-executable instructions may transform the CPU 902 by specifying how the CPU 902 transitions between states, thereby transforming the transistors or other discrete hardware elements constituting the CPU 902.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this description.

In light of the above, it should be appreciated that many types of physical transformations take place in the computer architecture 900 in order to store and execute the software components presented herein. It also should be appreciated that the computer architecture 900 may include other types of computing devices, including hand-held computers, embedded computer systems, personal digital assistants, and other types of computing devices known to those skilled in the art. It is also contemplated that the computer architecture 900 may not include all of the components shown in FIG. 9, may include other components that are not explicitly shown in FIG. 9, or may utilize an architecture completely different than that shown in FIG. 9.

Based on the foregoing, it should be appreciated that concepts and technologies for cross-store licensing for third party products have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A global licensing service, comprising:
a paid product catalog comprising data identifying at least one product and at least one product identifier for the at least one product;
a consumer catalog comprising data identifying a mapping between at least one consumer and at least one store consumer identifier; and
a license mapping store comprising data identifying a mapping between the at least one product and the at least one consumer.

2. The global licensing service of claim 1, wherein the paid product catalog further comprises data defining a number of instances of the at least one product that has been sold.

3. The global licensing service of claim 2, wherein the paid product catalog further comprises data defining an identifier of a plurality of stores in which the at least one product was sold.

4. The global licensing service of claim 1, wherein the at least one product comprises a default price and a premium price.

5. The global licensing service of claim 4, wherein the default price is a price assigned to the at least one product in a store selling the product if the at least one consumer did not previously purchase the at least one product.

6. The global licensing service of claim 4, wherein the premium price is a price assigned to the at least one product to provide the at least one consumer with a discounted price for subsequent purchases of the at least one product.

7. The global licensing service of claim 1, wherein the at least one consumer identifier comprises an identifier generated by the global licensing service, programmatically retrieved from a store the at least one consumer accessed to purchase the at least one product, or received through open authentication.

8. The global licensing service of claim 1, further comprising a registration interface to allow the at least one consumer to submit registration information of at least one device.

9. The global licensing service of claim 8, wherein the registration information comprises a unique identifier for the at least one device.

10. The global licensing service of claim 1, further comprising a developer data web service for receiving one or more inputs from a developer.

11. The global licensing service of claim 10, wherein the one or more inputs comprises a product name, a product identifier, a pairing of the at least one product with at least one store, a related product to the at least one product, and a price of the at least one product.

12. The global licensing service of claim 11, wherein the price of the at least one product comprises pricing models of the at least one product.

13. The global licensing service of claim 10, wherein the one or more inputs comprises a request to perform an audit on sales information of the at least one product across a plurality of stores.

14. A method for cross-store licensing of a product in a store, the method comprising:
receiving an identification of a consumer;
receiving an identification of product selected by the consumer for purchase;
accessing a global licensing service to determine if the product was previously purchased by the consumer;
in response to determining that the product was not previously purchased by the consumer, offering the product at a default price; and
in response to determining that the product was previously purchased by the consumer, determining if the product receives a previous purchase discount;
in response to determining that the product does not receive the previous purchase discount, offering the product at the default price; and
in response to determining that the product does receive the previous purchase discount, offering the product at a different price than the default price.

15. The method of claim 14, wherein determining if the product was previously purchased by the consumer comprises accessing a mapping of a global consumer identifier to the product to determine if the consumer has purchased the product at a second store.

16. The method of claim 14, further comprising receiving an identification of one or more devices to which the product should be downloaded.

17. The method of claim 16, wherein the identification is received from the consumer or the global licensing service.

18. The method of claim 16, further comprising downloading the product to the one or more devices, wherein downloading the product is initiated by the consumer or by the global licensing service.

19. The method of claim 14, further comprising determining the validity of a license associated with the product.

20. A cross-store licensing system, comprising:
a processor; and
a computer-readable storage medium in communication with the processor, the computer-readable storage medium comprising computer-executable instructions stored thereupon which, when executed by the processor, cause the processor to
receive an identification of a consumer;
receive an identification of a product for purchase by the consumer;
access a global licensing service;
determine the price of the product by retrieving a mapping of the consumer to the identification of the product;
in response to determining that the product was not previously purchased by the consumer, offer the product at a default price; and
in response to determining that the product was previously purchased by the consumer, determine if the product receives a previous purchase discount;
in response to determining that the product does not receive the previous purchase discount, offer the product at the default price; and
in response to determining that the product does receive the previous purchase discount, offer the product at a different price than the default price.
